(19) United States
(12) Patent Application Publication
(10) Pub. No.: US 2017/0335825 A1
(43) Pub. Date: Nov. 23, 2017

(54) TRANSITION ELEMENT FOR THE TRANSMISSION OF STRAINS BETWEEN A TOWER AND A SUB-STRUCTURE ON A FLOATING MONOLITHIC CONCRETE STRUCTURE FOR SUPPORTING MARINE WIND TURBINES

(71) Applicant: UNIVERSITAT POLITECNICA DE CATALUNYA, Barcelona (ES)

(72) Inventors: Climent MOLINS BORRELL, Barcelona (ES); Alexis CAMPOS HORTIGÜELA, Barcelona (ES)

(73) Assignee: UNIVERSITAT POLITECNICA DE CATALUNYA, Barcelona (ES)

(21) Appl. No.: 15/531,372

(22) PCT Filed: Nov. 4, 2015
(86) PCT No.: PCT/ES15/70789

§ 371 Date: May 26, 2017

(30) Foreign Application Priority Data
Nov. 27, 2014 (ES) P201431765

(51) Int. Cl. F03D 13/25; F03D 13/20; B63B 35/44; E02D 27/42; E02B 17/00

(52) U.S. Cl. CPC F03D 13/25; E02D 27/425; E02B 17/00; B63B 35/44; F03D 13/22; B63B 2035/446; E02B 2017/0091

(57) ABSTRACT

The invention relates to the embodiment, by means of a pre-stressed concrete layer, on floating structures for supporting wind turbines, of the transition zone between the tower, of a lesser diameter, and the concrete float, of a greater diameter, whether the tower is made of metal or concrete. Said layer of revolution has the optimum geometry for the correct transmission of forces between the two parts, the tower and the float, with a reduced thickness and without the need for external rigidifying and reinforcing elements on the surfaces thereof, which would increase the weight and the cost of the structure.

### CROSS-REFERENCE

This application is the entry into national phase of Application No. PCT/ES2015/070789 filed on Nov. 4, 2015 which claims the benefit of Spanish Application No. P201431765 filed on Nov. 27, 2014.

### FIELD OF THE INVENTION

The present invention relates to the embodiment, by means of a pre-stressed concrete layer, in floating structures for supporting wind turbines, of the transition zone between the tower, of a lesser diameter, and the concrete float, of a greater diameter, whether the tower is made of metal or concrete. Said layer of revolution has the optimum geometry for the correct transmission of strains between the two parts, the tower and the float, with a reduced thickness and without the need for external rigidifying and reinforcing elements on the surfaces thereof, which would increase the weight and the cost of the structure.

### BACKGROUND OF THE INVENTION

Ever since the implementation of the earliest offshore wind farms, industry has leaned more towards the use of concrete elements for supporting the towers that hold up the wind turbines as a result of the best performance of said material in the marine environment.

The transition between steel and concrete in these structures has a critical zone in connection with the durability of the structure, primarily due to fatigue in the concrete in the area where they are joined together.

The new design minimizes the concentrations of strains along the transition, assuring maximum service life due to both durability and fatigue, as it is a continuous, joint-free part connecting the tower with the sub-structure.

Following the teachings disclosed in WO2013/093160A1, which describes a one-piece floating monolithic reinforced and pre-stressed concrete structure, including tower and float, in a single element, the present invention proposes a transition geometry that allows transmitting strains generated at the base of the wind turbine tower to the floating element, of a greater diameter, without the need for stiffeners or other external elements on the actual concrete wall of the structure, which would increase weight and, therefore, cause a loss of buoyancy.

In the design of floating structures, the geometry of the section intersecting with mean sea level (msl) is a key factor for the correct hydrodynamic behavior of the structure, such that the diameter in said section is the least capable of withstanding design strains.

In contrast, the design of the float is focused on maximizing stability of the structure with the lowest possible depth, involving larger diameters than in the tower. This difference between diameters involves great concentrations of stress on the base of the tower and on the float, particularly in the case of transitions having a small length, or even transitions having nil length, wherein a key factor is the ratio between the diameters of the tower and the float.

In the case of monolithic concrete structures, wherein the tower and float form a single part and the prestressing strains of the concrete generate considerable deflection strains in the geometry changes, achieving a geometry which allows uniformly distributing stresses over the structure allows increasing durability of the structure as well as reducing the cost of making floating monolithic concrete structures.

The present invention is also valid in those cases comprising a tower made of metal in which the steel-concrete joint must be kept as far away as possible from the surface of the water for the sake of durability and tightness, allowing to perform the transition with concrete up to just a few meters above msl, where it connects with the tower. This solution minimizes durability and maintenance issues of the zone that is most exposed to the most aggressive environmental vectors.

In the case of concrete structures anchored to the sea bed by gravity, the present invention optimizes the distribution of stresses by increasing the diameter from the tower to the foundation.

### BRIEF DESCRIPTION OF THE DRAWINGS

FIG. 1 is a schematic elevational view of a floating structure for supporting marine wind turbines, where the location of the transition part according to the present invention is highlighted;

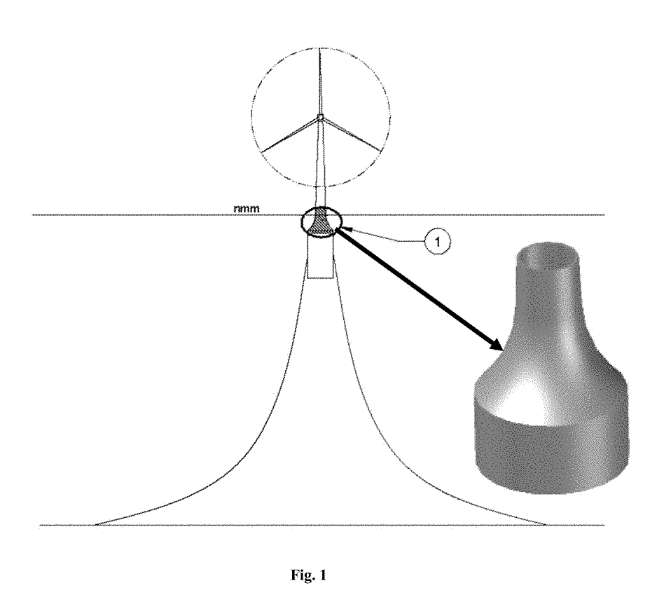

FIG. 2 is an elevational section view of the transition part, showing the either curved geometry or segmented geometry of the transition defining the transition length L depending on the radii of the tower and the float. Longitudinal steel prestressing tendons, as well as the main circumferential tendons handling the strains existing due to the change in geometry, can be seen. The circumferential reinforcement tendons distributed along the transition are also shown. Furthermore, it can be seen that the inner space is completely free of stiffening and/or reinforcing elements.

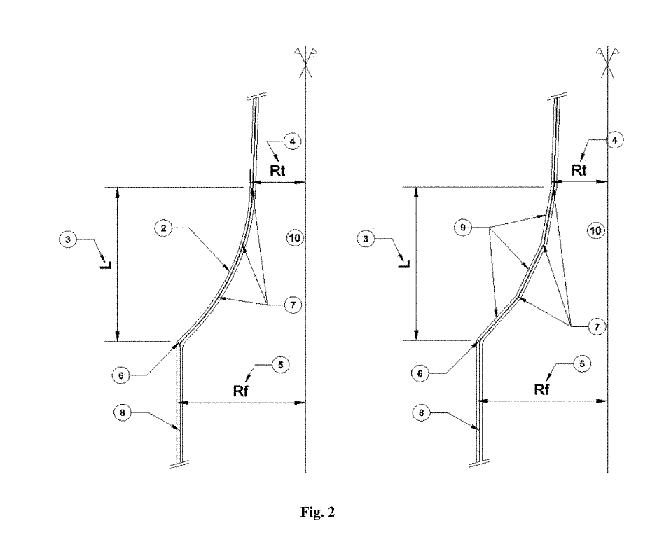

FIG. 3 shows a plan view of the transition, wherein the geometry of the circumferential prestressing tendons and of the longitudinal tendons providing continuity to those coming from the tower can be clearly seen.

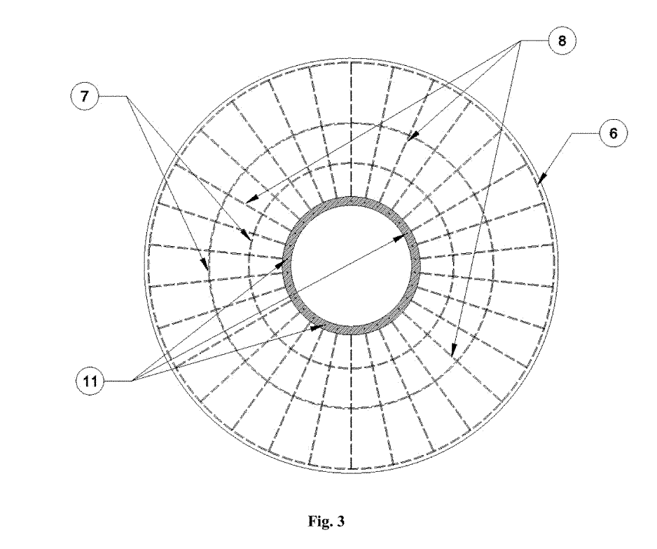

### DESCRIPTION OF THE INVENTION

By means of using a suitable geometry and steel tendons for longitudinal and circumferential prestressing, a smooth transmission of the strains generated in the tower to the float is achieved. It additionally helps improve other hydrodynamic aspects with respect to other solutions, as will be seen below.

Said transition comprises:
an arc of circumference tangent to the generatrix of the tower joining both parts together, forming a toroid-shaped transition.

Should it be needed, the transition can be done in two or more frustoconical segments by adapting the transitions to the original curvature. This option involves higher concentrations of stresses, which can in turn be absorbed by means of the concentrated circumferential prestressing in each transition change.

By adopting this geometry, which is either torus-shaped or based on cone frustums, suitable distribution of the longitudinal and transverse stresses on the concrete is obtained, including the loads of the tower plus those loads due to the prestressing of the tendons embedded in the concrete, whether they are longitudinal or transverse.

The meeting point of the float and the transition is circumferentially pre-stressed to absorb the stresses generated by the change in geometry, by providing a set of tendons clustered in the zone where the change is located, and other reinforcing tendons distributed throughout the transition to assure a full state of compression.

This state of compression assures durability of the floating structure throughout the entire underwater body and splash zone.

The longitudinal tendons correspond to the existing prestressing tendons at the base of the tower, providing them with continuity to the float through the transition. In the case of towers made of metal, the longitudinal tendons start from the beginning of the concrete structure above the msl.

In addition to the structural advantage, it must be observed that the transition increases the radius in a non-linear manner such that it allows moving larger diameters away from the surface of the sea, where the effects of the waves are maximal and decrease exponentially with depth, while they proportionally increase with diameter. This greatly improves the hydrodynamic response of the structure, being more permeable on the surface of the sea.

The transition shape also helps to prevent possible adverse effects in movement under severe wave conditions, where a significant part of the transition is temporarily exposed, causing significant variations to hydrostatic rigidity with the use of typical linear transitions, which must be compensated for in the design by means of the length of the transition, increasing the depth and/or radius of the float.

Furthermore, the smooth transition at the tower base allows for a greater radius around the tower with minimal depth than by means of other types transitions, which favors the passage of ships.

What is claimed is:

1. A concrete transition element between an underwater sub-structure and a tower of floating structures for supporting marine wind-driven power generators, wherein the underwater sub-structure is made of hollow concrete, characterized by comprising a pre-stressed concrete revolution layer having an axisymmetric circular transition geometry from the radius of the float to the radius of the base of the tower, said pre-stressed concrete revolution layer having a thickness comprised between a thickness of the tower and a thickness of the sub-structure, dispensing with reinforcements or stiffeners on outer surfaces thereof.

2. The sub-structure/tower concrete transition element according to claim 1, wherein a surface of the pre-stressed concrete revolution layer transition is tangent to a generatrix of the base of the tower.

3. The sub-structure/tower concrete transition element according to claim 1, wherein said axisymmetric circular transition geometry is adjusted by means of two or more straight segments providing two or more frustoconical segments in the pre-stressed concrete revolution layer.

4. The sub-structure/tower concrete transition element according to claim 1, wherein said pre-stressed concrete revolution layer transition comprises:
longitudinal steel prestressing tendons; and
circumferential steel prestressing tendons.
